(19) United States
(12) Patent Application Publication
(10) Pub. No.: US 2015/0010683 A1
(43) Pub. Date: Jan. 8, 2015

(54) FOOD STERILIZATION METHOD

(71) Applicant: Draco Natural Products, Inc., San Jose, CA (US)

(72) Inventors: Jerry Wu, San Jose, CA (US); Jianguo Chen, Cupertino, CA (US)

(21) Appl. No.: 13/933,617

(22) Filed: Jul. 2, 2013

(51) Int. Cl. A23L 3/005; A23L 2/42; A23L 3/015; A23L 2/48

(52) U.S. Cl. CPC A23L 3/0055; A23L 2/48; A23L 2/42; A23L 3/0155
USPC 426/490

(57) ABSTRACT

A food sterilization method combines membrane filtration with a high pressure process or a heating process. The disclosed method makes it possible for large scale commercialization of non-chemical, non-destructive food product sterilization. The food product thus processed retains its natural flavor and nutritional value with extended shelf life.

### TECHNICAL FIELD

Embodiments of this disclosure relate to methods for non-chemical, non-destructive food sterilization to remove and destroy pathogens. In particular, food sterilization methods combining membrane filtration with high pressure processes or heating processes are described. Embodiments of this invention effectively solve the shortcomings of those food sterilization practices of high pressure processing and heating treatment, expand the capability of membrane application as well as the capability of HPP and pasteurization, and help to keep the natural texture, flavor, color, and nutritional value while prolonging the shelf life of thus treated food.

### BACKGROUND

Food preservation can be dated back to ancient time. Over the years, people invented many sterilization methods to preserve their foods. The mostly used method to kill or inactivate pathogens in food is heating. While heating could effectively eliminate and inactivate food borne pathogens, it would at the same time change or destroy nutritional profiles, natural colors, and natural flavors of the foods.

Recently, demands for foods and cosmetic products with natural taste, flavor, color, nutritional values, and those processed organically are increasing rapidly. Current sterilization methods, such as heating, preservatives, gamma irradiation etc.

all have limitations to meet these requirements. Researchers in food industry and related fields are seeking other means of food sterilization that can preserve the natural status of the foods while extend their shelf life by inactivating microorganisms that cause food spoilage. High pressure processing (HPP) thus becomes a way of choice to sterilize food under high pressure to inactivate or destroy pathogens without changing natural status of the food during the process.

HPP is considered a non-thermal, natural pasteurization process. It involves subjecting the food to be treated to a very high pressure, usually 50,000 to 150,000 pounds per square inch (psi) or even higher. It is very effective at eliminating or inactivating yeasts and molds, harmful pathogens like E. coli, Salmonella, Listeria, and Cryptosporidium, and Psychotropic bacteria, and lactic acid bacteria. Food thus treated usually has a 3-log pathogen reduction, thus the shelf life is extended with original flavor almost intact.

Earlier methods of high pressure processing limit the pressure to 70,000 to 87,000 psi. US Patent Application Publication No. 2008/0311259 Al describes a method of high pressure pasteurization of liquid egg products. 2.5-log microorganism reduction is realized by such process.

US Patent Application 20080050507 discloses a high pressure processing for meat jerky and cheese that applies 80,000 to 145,000 psi to the product to achieve 4-5 log deduction of food pathogens.

High pressure processing is best suited for treating acidic food with pH ≦4.5; it is not ideal for foods with pH >4.5, especially neutral or weak alkaline liquid foods. In such instance, other means of sterilization such as heating are usually combined with HPP to achieve desired results. U.S. Pat. No. 6,207,215 B1 describes a process that combines high temperature and ultra-high pressure to sterilize food. The introduction of high pressure treatment into the process is claimed to reduce the time of thermal pasteurization, thus compensate some shortcomings of longer thermal processes. However, this process still requires subjecting the entire food product to heat treatment. The application is mainly for low acid food (pH 4.5) such as raw meat.

Current improvements on HPP processing are all focused on increasing pressure with modified equipment and longer processing time. However, due to intrinsic limitations of these methods, little advancement was achieved so far.

HPP processing is also limited by the size of equipment that can achieve ultra-high pressures. It is apparent to those skilled in the art that equipment that can achieve such high pressure of >125,000 psi is not easy to build and operate in a large scale to process a large quantity of food for commercialization. Moreover, all commercialized HPP processing in current industry is limited to treat semi-solids like those mentioned in the above patents; little success is achieved for treating liquid product on productive scale.

Although HPP processing is gaining popularity in recent years for its low temperature sterilization characteristics to keep treated food in its integral natural flavor and color, the above mentioned intrinsic limitations of this technique prevent its widespread large scale application in food sterilization industry. The embodiments of the current invention creatively combine applications from other field, i.e. membrane filtration, with HPP processing and heating sterilization, to form a food sterilization method that successfully overcomes the drawbacks of these techniques. From this disclosure, a large scale commercialized food sterilization is made possible while retain natural texture, flavor, color, nutritional value of the food being treated.

### SUMMARY

One key step of the present invention is to divide the liquid product into two parts, i.e., liquid and semi-solid sediment, by physical separation methods. The portion of the semi-solid from physical separation that requires HPP treatment is reduced to very low level, while the supernatant liquid accounted for most of the products is handed over to membrane filtration to complete its sterilization. The results of the combined treatment can achieve large-scale commercialization, while retaining the original nutrients, color, and natural flavor. Therefore, the technology of the present invention, the method of sterilization of the liquid product is a novel applicable to large-scale commercial production. As used herein the term “semi-solid” refers to any sediment from sedimentation and centrifugation, and any retentate from any filtration mechanism.

The membrane separation is a novel liquid separation and enrichment processing technology. Its principle is associated with a screening process based on membrane pore size, with pressure difference on both sides of the membrane as a driving force. The micropores on membrane serve as the filter medium under certain pressure difference that allows only those molecules with sizes smaller than the pores of the film surface to pass through the membrane and collected on the other side of the membrane as permeated liquid (supernatant), substances with size greater than the membrane pore size are trapped in the membrane to become concentrated semi-solid retentate, thus achieving the purpose of separation and concentration of the liquid product. Another feature of the membrane separation technique is a large-scale production of membrane separation can be easily assembled in parallel by a series of membrane filtration module. However, membrane separation has strict requirements for products to be separated; for liquid products with suspended solids or high viscosity, membrane separation technology is ineffective or impossible to achieve the desired separation results. Moreover, current membrane technology is mainly used to treat waste water and liquid clarification. To our knowledge, so far there is no published method of commercialized membrane sterilization process to preserve liquid food.

Embodiments of this disclosure take into consideration of the strengths and drawbacks of both HPP and heating pasteurization, seamlessly combine HPP, pasteurization, and membrane separation technology to achieve large-scale liquid sterilization process to extend shelf life, without sacrificing the natural flavor, color, and nutritional value of the liquid product. Embodiments of the present invention also overcome the limitations of high pressure, heat sterilization defects, and membrane separation technology to achieve sterilization of food, and make full use of the expertise of the membrane separation technology, HPP, and heat sterilization. Embodiments of this disclosure are a reversal of the traditional liquid sterilization methods, creatively partition the liquid products to two tasks through simple solid-liquid physical separation, combine high-pressure processing (HPP), heat treatment and membrane separation processes together, to sterilize liquid products in large scale production. The process is very easy to realize large-scale commercialized. For those skilled in the art, it is self-evident that any membrane filtration and high pressure process (HPP), as well as the combination of heat sterilization process can be used to implement embodiments of this invention.

In some exemplary embodiments, a method of processing a food product comprises the following steps. The food product is separated into a liquid portion and a semi-solid portion. The liquid portion is subjected to a membrane filtration process to obtain a retentate portion and a permeate portion, thereby removing microorganisms from the permeate portion. The semi-solid portion is subjected to a sterilization process to obtain a sterilized semi-solid portion, thereby removing microorganisms from the sterilized semi-solid portion. The permeate portion and the sterilized semi-solid portion are then combined to obtain a sterilized food product. In some embodiments, the retentate portion obtained in the membrane filtration process is combined with the semi-solid portion of the food product, and the combined retentate portion and the semi-solid portion are then subjected to the sterilization process to obtain the sterilized semi-solid portion.

The membrane filtration process may comprise one membrane filtration step, or two or more membrane filtration steps. The membrane filtration process may be configured to provide 2-log or more reduction of microorganisms.

The sterilization process that the semi-solid portion or the combined semi-solid portion and the retentate portion is subjected to may be either a high pressure process (HPP) or a heating process. The high pressure process may be configured to provide 2-log or more reduction of microorganisms. The sterilization process may be carried out under a pressure ranging from 50,000 psi to 200,000 psi. The sterilization process may also be a heating process configured to provide 5-log or more reduction of microorganisms.

The food product that can be processed by the disclosed method may be any liquid products including fruit juices, vegetable purees, and liquid cosmetic products comprising natural extracts, and so on. The food product may include about 70-99% by weight of liquid and about 1-30% by weight of solid, or about 90-95% by weight of liquid and about 5-10% by weight of solid.

In some exemplary embodiments, a method of processing a food product comprises the following steps. The food product is separated into a liquid portion and a semi-solid portion. The liquid portion is subjected to a membrane filtration process to obtain a retentate portion and a permeate portion, thereby removing microorganisms from the permeate portion. The semi-solid portion is combined with the retentate portion, and the combined semi-solid portion and retentate portion are subjected to a high pressure process to yield a sterilized semi-solid portion, thereby removing microorganisms from the sterilized semi-solid portion. The permeate portion and the sterilized semi-solid portion are then combined to obtain a sterilized food product.

In some exemplary embodiments, a method of processing a food product comprises the following steps. The food product is separated into a liquid portion and a semi-solid portion. The liquid portion is subjected to a membrane filtration process to obtain a retentate portion and a permeate portion, thereby removing microorganisms from the permeate portion. The semi-solid portion is combined with the retentate portion, and the combined semi-solid portion and retentate portion are subjected to a heating process to yield a sterilized semi-solid portion, thereby removing microorganisms from the sterilized semi-solid portion. The permeate portion and the sterilized semi-solid portion are then combined to obtain a sterilized food product.

This Summary is provided to introduce selected embodiments in a simplified form and is not intended to identify key features or essential characteristics of the claimed subject matter, nor is it intended to be used as an aid in determining the scope of the claimed subject matter. Other embodiments of the disclosure are further described in the Detail Description.

### BRIEF DESCRIPTION OF THE DRAWINGS

These and other features and advantages of the disclosed methods and apparatuses will become better understood upon reading of the following detailed description in conjunction with the accompanying drawings and the appended claims provided below, where:

FIG. 1 is a flowchart illustrating an exemplary method of processing food products according to some embodiments of this disclosure.

### DETAILED DESCRIPTION

Various embodiments of methods for food sterilization are described. It is to be understood that the disclosure is not limited to the particular embodiments described as such may, of course, vary. An aspect described in conjunction with a particular embodiment is not necessarily limited to that embodiment and can be practiced in any other embodiments. For example, while various embodiments are described in conjunction with a food product, it will be appreciated the method can be implemented to process any drinks, beverages, soups, sauces, herbal extracts, any liquid extracts, cosmetic products in liquid vehicles, juices, purees, etc.

The food sterilization methods of the disclosure combine a membrane filtration process with a high pressure process or a heating process to remove or inactivate spoilage causing microorganisms from the food, thus increasing the shelf life of the liquid food. The membrane filtration does not require any heating and cooling cycle except for natural temperature fluctuation during the process, and thus it is an energy efficient process. Analysis of the data collected from production reveals that while energy consumption to process 1 metric ton of liquid food by the most efficient thermal sterilization process is about 2,000 kcal, while HPP processing needs about 4000 kcal energy to do the same task; on the other hand, membrane filtration only requires 800 kcal to achieve the same effective sterilization. Most importantly, embodiments of the current invention retain most of the natural flavor and nutritional value in the processed products because there is no heating or preservatives involved in processing the liquid portion of the product.

After physical separation by such means as centrifuging or filtration etc., the liquid portion that constitutes the majority of the liquid food product volume may be fed into a membrane filtration module where microorganisms can be removed by sieving, filtration, and adsorption mechanism of the membrane. The filtrate thus collected may be a sterilized liquid with great reduction of microorganisms. Log reduction of microorganisms can be controlled by selecting membranes with different pore sizes, materials, and filtration conditions. A secondary membrane filtration step can be added to further reduce microorganisms. The pore size of the secondary membrane module can be the same as that of the first membrane module or smaller to remove smaller pathogens. The two-stage membrane filtration can result in a liquid product with a greater log reduction of microorganisms.

The semi-solid portion from the physical separation, such as sediment from ultracentrifuging or cake from filtration, may constitute a small portion of the volume, usually less than 10% of the total liquid food product. The semi-solid portion may be further sterilized by a high pressure process or a heating process. For such purpose, FresherTech Duo H200L/600F by CHIC Group Global Co., Ltd., QFP 350L1600 High Pressure Processing System by Avure Technologies, and any other similar HPP systems in today or future market can be used. After HPP or heating sterilization, the treated sediment and cake may be combined with the filtrate and packaged aseptically. Alternatively, the filtrate alone can be packaged aseptically to form different sterilized liquid products. Since only a small portion of the liquid product, e.g., about 10% is processed by HPP or heating, the production capability of the high pressure equipment, especially that of HPP, can be increased by 9 times, thus overcoming the capacity limitation of the high pressure processing equipment, whose size is limited by the pressure it can be attained. On the other hand, while heating processing of a small portion of the liquid product may involve some shortcomings of thermal processing, the majority of the liquid is processed non-thermally. Therefore, most natural flavors and nutritional value of the food are retained in the final product.

The disclosed method is a non-chemical, non-destructive sterilization method for food, especially for liquid food. There is no any preservative added and almost no denature process made to the liquid food. The method combines membrane filtration with high pressure processing to greatly increase the production capacity, and retain the natural flavor and nutritional value of the food processed. Therefore, the disclosed method overcomes the capacity limitation of the conventional methods for large scale commercialization.

The liquid food products that can be processed according to the disclosed method include, but are not limited to, any drinks, beverages, soups, sauces, herbal extracts, any liquid extracts, cosmetic products in liquid vehicles, juices, purees, etc. In particular embodiments, fruit and vegetable juices and purees, and liquid cosmetic products comprising natural extracts in water or glycols can be processed using the disclosed method.

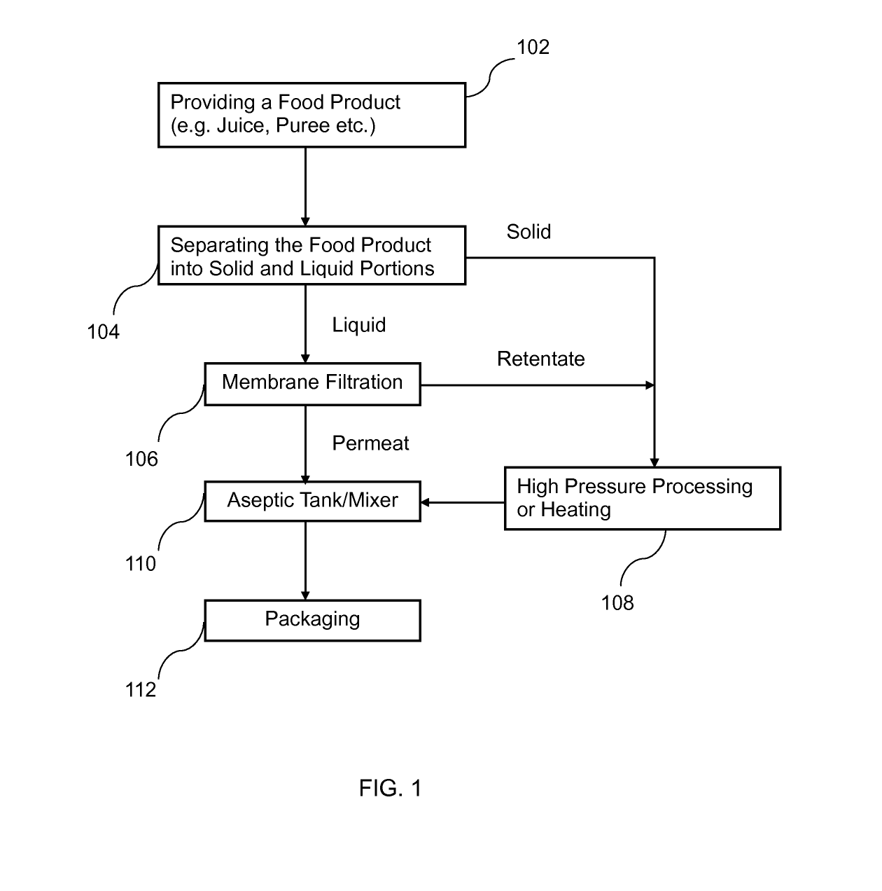

Referring to FIG. 1, an exemplary embodiment is now described. A liquid food product may be provided (step 102) and separated into a semi-solid portion and a liquid portion (step 104). Any equipment that is capable of separating solids from liquids can be used. The means for separating the solid from liquid include centrifuging, sedimentation, filtration, sieving, etc. Solids with particle size greater than 10 μm are usually separated from the liquid phase. Depending on the type of liquid product treated, the solid portion may range from 1 to 30% or from 5 to 10% by weight of the total liquid product.

After separation from the solid, the solution that constitutes most of the liquid product may be fed into a membrane filtration system (step 106). Membranes with a pore size between 100,000 MWCO and 1.0 μm may be employed for the filtration. In some embodiments, membranes with a pore size between 0.01 μm and 0.2 μm may be used. Microorganisms and other particles that are larger than or similar to the pore size of the membrane may be removed by the membrane through the combinative action of sieving, filtration, and adsorption mechanism. The pressure of the membrane filtration system may be slightly positive to maintain a steady flow of the stream in and out, usually in the range of 0.15-0.25 MPa. Liquid with soluble small molecules of nutrients can be harvested on the other side of the membrane. If needed, a secondary membrane filtration step can be added to further reduce microorganisms from the liquid. These can be microfiltration, ultrafiltration, and nanofiltration, or any combination thereof.

The semi-solid deposit that is blocked by the membrane may form a cake layer that may be collected from time to time and treated either by a high pressure process or a heating process such as a high temperature, short time process (HTST) (step 108).

Any membrane filtration modules with suitable pore sizes capable of removing and reducing pathogens may be used. Examples include Ultrafiltration Spiral Elements and Microfiltration Spiral Elements series from Koch Membrane Systems, DairyUF™ series from Hydranautics, and Dairy Ultra UF from General Electric.

The sediment from physical separation and the cake from membrane filtration may be combined, and the combined semi-solid may be subjected to a high pressure process or a heating process (step 108). The high pressure process may be carried out at a pressure ranging from 50,000 psi to 200,000 psi, preferably from 800,000 psi to 110,000 psi, to destroy or inactivate microorganisms in the semi-solid. Any high pressure processing equipment capable of delivering such high pressure and reasonable log reduction, such as those mentioned above, may be used to achieve the sterilization.

Alternatively, the combined semi-solid can be treated by a heating process to destroy or inactivate microorganisms. It is apparent to those skilled in the art that any heating mechanism that can destroy and reduce food borne pathogens can be used to achieve that purpose. The heating process may be carried out by boiling at 100° C. for more than 10 minutes, steaming in an autoclave at 15 psi, 120° C. for 15 minutes, HTST pasteurization at 72° C. for 15 seconds, or an ultra high temperature treatment at 140° C. for 1 second. Any commercially available heating equipment can be used to achieve this purpose.

The sterilized liquid from membrane filtration and sterilized semi-solid from HPP or heating treatment may be combined (step 110) and packaged (step 112) in a sterilized environment to obtain a final liquid food product that retains its natural flavor and nutritional value. One feature of the disclosed method is to combine a membrane filtration process with a high pressure processing or a heating process. For high pressure processing equipment that can handle 350 L product at a time, the disclosed method can treat 3,500 kg food product in one processing cycle. The production volume can thus increase 10 times. This dramatic increase in production volume overcomes the limitation of the size of high pressure processing equipment, thus makes it possible for large quantity commercialization of non-destructive, non-chemical preservation of food. Moreover, the energy consumption for implementing embodiments of the present invention is less than half of the traditional thermal processing and three times less than HPP processing.

The following examples are provided to illustrate embodiments of the disclosure but are by no means intended to limit its scope.

### EXAMPLE 1

1500 L orange juice is filtered by frame filter at 0.10-0.2 MPa constant pressure and average velocity of 485-520 L/h to get 1470 L filtrate. The filtrate is centrifuged by a horizontal centrifuge system to obtain 1470 L supernatant and 2.5 kg semi-solid. Operating parameters are as follows: feed pump speed, 350-380 r/min; drum speed 3000-3300 r/min; differential speed 12-20 r/min. After centrifugation, the total plate count (TPC) of supernatant is tested to be 40,000/g. The resulting supernatant liquid is further filtered through a hollow fiber membrane filter. The operating parameters are as follows: fiber diameter, 1.0 mm; inlet pressure, 0.1-0.3 MPa; permeate side back pressure 0.08-0.15 MPa; pressure difference, 0.10-0.15 Mpa. A total of 1450 L sterilized orange juice is obtained from the permeate. The total plate count of the juice after membrane filtration is <10/g, achieving a 4-log reduction.

The combined semi-solid from frame filter filtration, centrifugation, and membrane filtration totals 15 kg that is treated by HPP system with 80000-100000 psi pressure. Prior to the HPP processing, the total plate count of the semi-solid is tested to be 34,000/g; after HPP treatment, the total plate count becomes 42/g, achieving a 3-log reduction. After releasing of pressure, the supernatant from membrane filtration and semi-solid from HPP are mixed together in a sterile mixing tank. The final mixed liquid product has a total plate count of 13/g and is packaged under sterile condition.

### EXAMPLE 2

3000 L purple sweet potato extract is centrifuged to obtain 2980 L supernatant and 37 kg of semi-solid. The operating parameters are as follows: feed pump speed, 360-420 r/min; drum speed, 3100-3300 r/min; differential speed, 10-15 r/min. The total plate count of the supernatant from is measured to be 156,000/g. This part of the liquid is filtered through a 0.12 μm pore size microporous membrane filter with operating pressure of 0.2-0.3 Mpa to obtain about 2975 L semi-sterilized purple potato juice. To further reduce microorganisms, this semi-sterilized purple potato juice is further filtered by ultrafiltration system. The specific operating conditions are as follows: inlet pressure, 0.1-0.3 MPa; permeate side pressure, 0.10-0.15 MPa; pressure difference, 0.03-0.06 MPa. After these two steps, the total plate count of the liquid is tested to be 30/g, reduced by about four orders of magnitude. Meanwhile, remenants from the centrifugation and from the membrane filtration are combined to obtain a semi-solid of approximately 41 kg. This semi-solid is treated by high temperature short time (HTST) pasteurization at 90-95° C. for 30 seconds. Total plate count before pasteurization is found to be 139,000/g; after pasteurization, it decreases to 50/g, a 3.5 log reduction. The membrane filtered liquid and HTST treated semi-solid are mixed together in a sterile mixing tank, the total plate count of the final combined product is detected to be 38/g that is packaged under sterile conditions.

### EXAMPLE 3

55 kg of spinach extract is separated by natural sedimentation; the supernatant is centrifuged by low speed centrifuge with speed of 5000 r/min to isolate 54.2 kg liquid and 0.8 kg semi-solid. The liquid supernatant from centrifugation has a total plate count of 42,600/g. This part of the liquid is further filtered through a membrane filter. The operation parameters are as follows: inlet pressure, 0.25 MPa, membrane pore size, 0.8 μm. 53.7 kg of semi-sterilized spinach juice is collected from the permeate. This spinach juice is further filtered through a 0.22 μm membrane filter system with inlet pressure of 0.18 MPa. After these two steps, the liquid collected has a total plate count of 50/g, a 3 log reduction. Meanwhile, 2.1 kg semi-solid from sediments of natural sedimentation and centrifugation, and retentate from the membrane filtration are combined and heated at 80-100° C. for 60 seconds. The total plate count of the semi-solid before pasteurization is tested to be 43,000/g; after pasteurized the total plate count is reduced to 90/g, achieving about 3 log reduction. The treated semi-solid and membrane filtered supernatant are mixed together in a sterile tank. The final combined liquid product has a total plate count of 60/g that is packaged under sterile conditions.

Exemplary embodiments of food sterilization methods are described. Those skilled in the art will appreciate that various modifications may be made within the spirit and scope of the disclosure. All these or other variations and modifications are contemplated by the inventors and within the scope of the disclosure.

1. A method of processing a product, comprising:
separating the product into a liquid portion and a semi-solid portion;
subjecting the liquid portion to a membrane filtration process to obtain a retentate portion and a permeate portion, thereby removing microorganisms from the permeate portion;
subjecting the semi-solid portion to a sterilization process to obtain a sterilized semi-solid portion, thereby removing microorganisms from the sterilized semi-solid portion; and
combining the permeate portion with the sterilized semi-solid portion to obtain a sterilized product.

2. The method of claim 1 further comprising combining the retentate portion with the semi-solid portion, and subjecting the combined retentate portion and the semi-solid portion to the sterilization process to obtain the sterilized semi-solid portion.

3. The method of claim 1 wherein the membrane filtration process comprises passing the liquid portion through a membrane system configured to provide 2-log or more reduction of microorganisms.

4. The method of claim 1 wherein the membrane filtration process comprises one or more membrane filtration steps.

5. The method of claim 1 wherein the sterilization process to which the semi-solid portion is subjected comprises a high pressure process configured to provide 2-log or more reduction of microorganisms.

6. The method of claim 1 wherein the sterilization process to which the semi-solid portion is subjected comprises a high pressure process which is carried out under a pressure ranging from 50,000 psi to 250,000 psi.

7. The method of claim 1 wherein the sterilization process to which the semi-solid portion is subjected comprises a heating process configured to provide 2-log or more reduction of microorganisms.

8. The method of claim 1 wherein the step of separating the product into a liquid portion and a semi-solid portion is carried out by at least one of centrifuging, sedimentation, filtration, and sieving.

9. The method of claim 1 wherein the liquid portion of the product constitutes about 65-99% by weight of the product and the semi-solid portion constitutes about 1-35% by weight of the product.

10. The method of claim 9 wherein the liquid portion of the product constitutes about 90-99% by weight of the product and the semi-solid portion constitutes about 1-10% by weight of the product.

11. The method of claim 1 wherein the product comprises at least one of fruit juices, vegetable juices, fruit purees, vegetable purees, natural extracts, beverage, protein and dairy drinks, liquid form of food products, liquid pet foods, fermentation products, liquid cosmetic and personal care products.

12. A method of processing a product, comprising:
separating the product into a liquid portion and a semi-solid portion;
subjecting the liquid portion to a membrane filtration process to obtain a permeate portion and a retentate portion, thereby removing microorganisms from the permeate portion;
combining the retentate portion with the semi-solid portion;
subjecting the combined retentate portion and the semi-solid portion to a high pressure process to yield a sterilized semi-solid portion, thereby removing microorganisms from the sterilized semi-solid portion; and
combining the permeate portion with the sterilized semi-solid portion to obtain a sterilized product.

13. The method of claim 12 wherein the high pressure process is carried out under a pressure ranging from 50,000 psi to 250,000 psi.

14. The method of claim 12 wherein the product comprises at least one of fruit juices, vegetable purees, liquid cosmetic products comprising natural extracts.

15. A method of processing a product, comprising:
separating the product into a liquid portion and a semi-solid portion;
subjecting the liquid portion to a membrane filtration process to obtain a permeate portion and a retentate portion, thereby removing microorganisms from the permeate portion;
combining the retentate portion with the semi-solid portion;
subjecting the combined retentate portion and the semi-solid portion to a heating process to yield a sterilized semi-solid portion, thereby removing microorganisms from the sterilized semi-solid portion; and
combining the permeate portion with the sterilized semi-solid portion to obtain a sterilized product.

16. The method of claim 15 wherein the heating process is carried out under a temperature ranging from 60-160° C. for a time period ranging from 1 second to 15 minutes.

17. The method of claim 16 wherein the product comprises at least one of fruit juices, vegetable juices, fruit purees, vegetable purees, natural extracts, beverage, protein and dairy drinks, liquid form of food products, liquid pet foods, fermentation products, liquid cosmetic and personal care products.

18. The method of claim 2 wherein the sterilization process to which the combined retentate portion and semi-solid portion is subjected comprises a high pressure process configured to provide 2-log or more reduction of microorganisms.

19. The method of claim 2 wherein the sterilization process to which the combined retentate portion and semi-solid portion is subjected comprises a high pressure process which is carried out under a pressure ranging from 50,000 psi to 250,000 psi.

20. The method of claim 2 wherein the sterilization process to which the combined retentate portion and semi-solid portion is subjected comprises a heating process configured to provide 2-log or more reduction of microorganisms.

21. The method of claim 20 wherein the heating process is carried out under a temperature ranging from 70-140° C. for a time period ranging from 1 second to 15 minutes.

22. The method of claim 1 wherein the sterilization process to which the semi-solid portion is subjected comprises a heating process configured to provide 2-log or more reduction of microorganisms.

23. The method of claim 22 wherein the heating process is carried out under a temperature ranging from 70-140° C. for a time period ranging from 1 second to 15 minutes.
